(19) United States
(12) Patent Application Publication
(10) Pub. No.: US 2019/0064855 A1
(43) Pub. Date: Feb. 28, 2019

(54) PRESSURE REGULATOR VENT GUARD AND METHOD OF USE

(71) Applicant: MARSHALL EXCELSIOR CO., Marshall, MI (US)

(72) Inventors: Frederick W. Blanchard, Caldwell, ID (US); Michael J. Tartaglia, Marshall, MI (US)

(73) Assignee: MARSHALL EXCELSIOR CO., Marshall, MI (US)

(21) Appl. No.: 16/108,191

(22) Filed: Aug. 22, 2018

Related U.S. Application Data
(60) Provisional application No. 62/549,158, filed on Aug. 23, 2017.

(51) Int. Cl. G05D 16/06; F16K 17/36; F17C 13/00

(52) U.S. Cl. CPC G05D 16/0655; F16K 17/36; F17C 13/002; F17C 2270/0745; F17C 2250/043; F17C 2250/0636; F17C 2205/0338

(57) ABSTRACT

A pressure regulator vent guard configured to be in fluid communication with a non-working fluid chamber of a pressure regulator diaphragm. The pressure regulator vent guard includes a housing defining a compartment and a vent diaphragm configured to separate the housing compartment into a first vent chamber and a second vent chamber, the first vent chamber adapted to be in fluid communication with the non-working fluid chamber, and the second vent chamber in fluid communication with the atmosphere. The vent diaphragm seals the non-working fluid chamber from fluid communication with the atmosphere.

### RELATED APPLICATION

This application claims priority under 35 U.S.C. § 119(e) to U.S. provisional patent application 62/549,158, filed Aug. 23, 2017, the disclosure of which is hereby incorporated by reference in its entirety.

### TECHNICAL FIELD

The present invention relates generally to pressure regulators and, more particularly, to a vent guard for a pressure regulator.

### BACKGROUND

Pressure regulators are configured to produce a desired output pressure of a fluid from an input pressure of the fluid. Often, pressure regulators are configured to reduce the fluid pressure so that the output pressure is substantially less than the input pressure.

Single stage and dual stage pressure regulators are available to reduce fluid pressure. Single stage regulators are often employed to regulate fluid pressure in gas appliances such as gas grills. Dual stage pressure regulators are often employed for regulating fluid pressure of natural gas or propane residential heating systems. In general, dual stage pressure regulators provide for additional control in providing a constant desired outlet pressure. For example, a dual stage pressure regulator can have a first stage that reduces the fluid pressure from about two hundred or more pounds per square inch above atmospheric pressure (“psig” or “psi”) in a propane storage tank, to around ten psi, and then a second stage that further reduces the ten psi propane fluid outlet of the first stage to around one-half psi output pressure from the dual stage pressure regulator.

Typically, pressure regulators include a housing formed of upper and lower housing portions that are connected together with fasteners, and a flexible diaphragm located between the upper and lower housing portions. The fluid whose pressure is being regulated is referred to as the working fluid. The fluid on the other side of the diaphragm from the working fluid is referred to as the non-working fluid. The flexible diaphragm separates the regulator into a working fluid chamber in one of the housing portions and a non-working fluid chamber in the other housing portion. The working fluid chamber holds the working fluid. The non-working fluid chamber holds the non-working fluid. The flexible diaphragm seals the working fluid chamber from the non-working chamber. Pressure regulators often couple the flexible diaphragms to valve mechanisms that move a seal relative to an orifice to maintain an approximately constant outlet pressure of the working fluid through a range of fluid flow rates.

As the diaphragm moves in response to the fluctuations in pressure of the working fluid, the diaphragm displaces fluid in the non-working fluid chamber by changing the respective volumes of the working fluid chamber and the non-working fluid chamber. In response to such movement, the non-working fluid must be freely expelled from or drawn into the non-working fluid chamber to accommodate the pressure and/or volume changes within the non-working fluid chamber. In order to relieve the pressure caused by the displacement of fluid in the non-working side, in general, the non-working fluid chamber may be vented to the atmosphere. Venting to the atmosphere permits the fluid within the non-working side to be drawn in or expelled as needed in response to displacement caused by the diaphragm.

Pressure regulators are often installed outdoors or otherwise outside of a controlled environment, and therefore, may be exposed to the elements, moisture, temperature extremes and/or other environmental or atmospheric conditions. For example, by exposing the non-working fluid chamber via the vent to the atmosphere, either liquid water or water vapor may enter the vent and the non-working fluid chamber. And as the pressure regulator may be exposed to an environment below the freezing point temperature of water, the water or water vapor could freeze within the non-working fluid chamber. In addition, in general, compressible vapors and gasses exhibit a cooling effect during expansion due to a reduction in pressure. Pressure regulators can reduce pressure by, for example, expanding a compressible vapor and/or gas. In doing so, the expansion generates a cooling effect which can create temperatures internal to the pressure regulator below the temperature of the surrounding environment and below the freezing point of water. As such, these compounding factors may subject any water or water vapor to freezing temperatures within the pressure regulator, and in particular, within the non-working fluid chamber. Liquid water that enters the non-working fluid chamber through the pressure regulator vent can be exposed to such low temperatures and can freeze and impair and/or inhibit the movement of the flexible diaphragm or block the pressure regulator vent. When vapor containing water, for example, moist air, is drawn into the non-working side of a pressure regulator at such low temperatures, condensation can form and accumulate in the non-working fluid chamber, which can also lead to the same freezing issue.

Moreover, as discussed above, the vent to the non-working fluid chamber is intended to allow fluid to be drawn in or expelled from the non-working side of the pressure regulator diaphragm to accommodate for volume and pressure changes due to the movement of the pressure regulator diaphragm. However, debris can block the vent and prevent proper flow of fluid to and from the non-working fluid chamber. In situations such as these, some known pressure regulator vents contain relief mechanisms to discharge excess pressure buildup in the event of a malfunction or abnormal condition, however, some pressure regulator vents do not have a relief function.

When a pressure regulator is used with liquefied petroleum gas (“LP-Gas”) vapor service in a domestic application, for example, home heating, NFPA-58, the National Fire Protection Association's Liquefied Petroleum Gas Code, requires two stages of regulation. A first stage reduces inlet pressure from container or distribution pressure to approximately ten psi outlet pressure. Next a second stage regulator reduces first stage outlet pressure to an appliance operating pressure of approximately one-half psi.

Both stages of regulation are allowed to be contained in a single unit, known in the trade as an integral two stage pressure regulator. Since integral two stage regulators contain both stages of pressure reduction in a single body, the expansion cooling effect is compounded, making these type of regulators especially prone to first and/or second stage vent freeze-up issues.

NFPA-58 also requires that LP-Gas regulator vents be designed to allow condensation to drain. It also requires that all vents be installed pointing vertically down to afford protection from the elements. Vertical installation allows proper drainage of water that can accumulate in the vent chamber. On some pressure regulators, a screen is installed over the vent to keep debris from entering the vent chamber. Since integral two stage regulators have two vents that have to be addressed, compliant installations are presently limited in allowable orientations or require alterations, such as the addition of an elbow fitting, to redirect the vent discharge. A device capable of complying with NFPA-58 and being installed either vertically or horizontally would have advantages of easier installation, simplicity, and reduction of cost, while allowing more flexibility of installation orientation.

Protection from the elements is also allowed by NFPA-58 to be integral to the regulator's design. Unlike separate first and second stage regulators, the first stage vent in fluid communication with the non-working chamber of an integral two stage regulator is typically non-relieving, e.g., does not contain a relief mechanism for the working fluid chamber, but the non-working fluid chamber is open to the atmosphere. As a result, a device that offers protection of a non-relieving pressure regulator vent from the elements by precluding ingress of, for example, liquid water and moist air, would have the advantages of improved ease of installation and allowing more flexibility of installation orientation.

Therefore, there is a need in the art for a device that prevents the ingress of water and water vapor to the non-working fluid chamber of a pressure regulator, while still providing the non-working fluid side to be responsive to displacement of fluid caused by changes in pressure in the working fluid chamber, thereby permitting the pressure regulator diaphragm to function as intended. Moreover, because both one stage and two stage pressure regulators are known and in use, there is also a need in the art for a method of installing and using such a device with a pressure regulator.

### SUMMARY

Accordingly, the present disclosure provides a pressure regulator vent guard configured to be in fluid communication with a non-working fluid chamber of a pressure regulator diaphragm, the pressure regulator vent guard comprising: a housing defining a compartment; a vent diaphragm configured to separate the housing compartment into a first vent chamber and a second vent chamber, the first vent chamber adapted to be in fluid communication with the non-working fluid chamber, and the second vent chamber in fluid communication with an atmosphere, wherein the vent diaphragm seals the non-working fluid chamber from fluid communication with the atmosphere; and a protective structure adapted to prevent ingress of debris from the atmosphere to the second vent chamber, wherein the vent diaphragm is adapted to move to increase or decrease a volume of the first chamber in response to the fluid communication with the non-working fluid chamber.

The present disclosure also provides a pressure regulator comprising: a pressure regulating stage, the pressure regulating stage comprising: a movable diaphragm separating a non-working fluid chamber from a working-fluid chamber; and a pressure regulator diaphragm inlet bore in fluid communication with the non-working fluid chamber; and a vent guard in fluid communication with the non-working fluid chamber, the vent guard comprising: a housing comprising a compartment; a vent diaphragm configured to separate the housing compartment into a first vent chamber and a second vent chamber, the first vent chamber in fluid communication with the non-working fluid chamber, and the second vent chamber in fluid communication with an atmosphere, wherein the vent diaphragm seals the non-working fluid chamber from fluid communication with the atmosphere.

The present disclosure further provides a method of regulating pressure comprising: reducing a pressure of a fluid passing through a pressure regulator, wherein the pressure regulator comprises a non-working fluid chamber in fluid communication with a vent guard, wherein the vent guard comprises: a housing defining a compartment; and a vent diaphragm adapted to separate the housing compartment into a first vent chamber and a second vent chamber, the first vent chamber adapted to be in fluid communication with the non-working fluid chamber, and the second vent chamber in fluid communication with an atmosphere, wherein the vent diaphragm seals the non-working fluid chamber from fluid communication with the atmosphere.

The present disclosure additionally provides a method of installing a vent guard comprising: providing a pressure regulator comprising a non-working fluid chamber in fluid communication with an atmosphere; and connecting a vent guard to the pressure regulator thereby sealing the non-working fluid chamber from fluid communication with an atmosphere, wherein the vent guard comprises: a housing comprising a compartment; and a vent diaphragm configured to separate the compartment into a first vent chamber and a second vent chamber, the first vent chamber adapted to be in fluid communication with the non-working fluid chamber of the pressure regulator, and the second vent chamber in fluid communication with the atmosphere, wherein the vent diaphragm seals the non-working chamber from fluid communication with the atmosphere.

One particular advantage provided by at least one embodiment of the present disclosure is that the vent guard seals the non-working fluid chamber of the pressure regulator from the atmosphere. This prevents the ingress of debris or water into the non-working fluid chamber, which may lead to for example, clogging of mechanics located within the non-working chamber or freezing of water within the limited space of the non-working fluid chamber, which can lead to cracking and the inability of the diaphragm to properly regulate the pressure reduction.

Another advantage of at least one embodiment of the present disclosure is that the vent guard can be installed into pressure regulators in commercial use by means of the vent ports, thereby upgrading the existing condition and not necessitating new installation of pressure regulators.

Yet another advantage of the present disclosure is that the vent guard can be incorporated into a pressure regulator while the pressure regulator is either in or out of operation. This feature allows the vent guard to be installed in pressure regulators either prior to service or while in service without requiring a cessation of pressure regulation.

Another advantage of the present disclosure is that through incorporation of the vent guard of the present disclosure into a pressure regulator, the pressure regulator can be installed in any orientation without the need for directional drainage.

These and other features and advantages of the present disclosure will be readily appreciated from the following detailed description taken in conjunction with the accompanying drawings.

### BRIEF DESCRIPTION OF THE DRAWINGS

FIG. 1 is a sectional view of a prior art two stage pressure regulator.

FIG. 2 is a close-up view of the portion 106 of the regulator of FIG. 1.

FIG. 3 is a side view of a two stage pressure regulator having a vent guard with the first stage according to an embodiment of the present disclosure.

FIG. 4 is a sectional view of FIG. 3.

FIG. 5 is a close-up of view of the portion 107 of FIG. 3.

FIG. 6 is a close-up view of the portion 108 of FIG. 4.

FIGS. 7 through 9 are views similar to FIG. 6, showing the vent diaphragm at a variety of positions.

### DETAILED DESCRIPTION

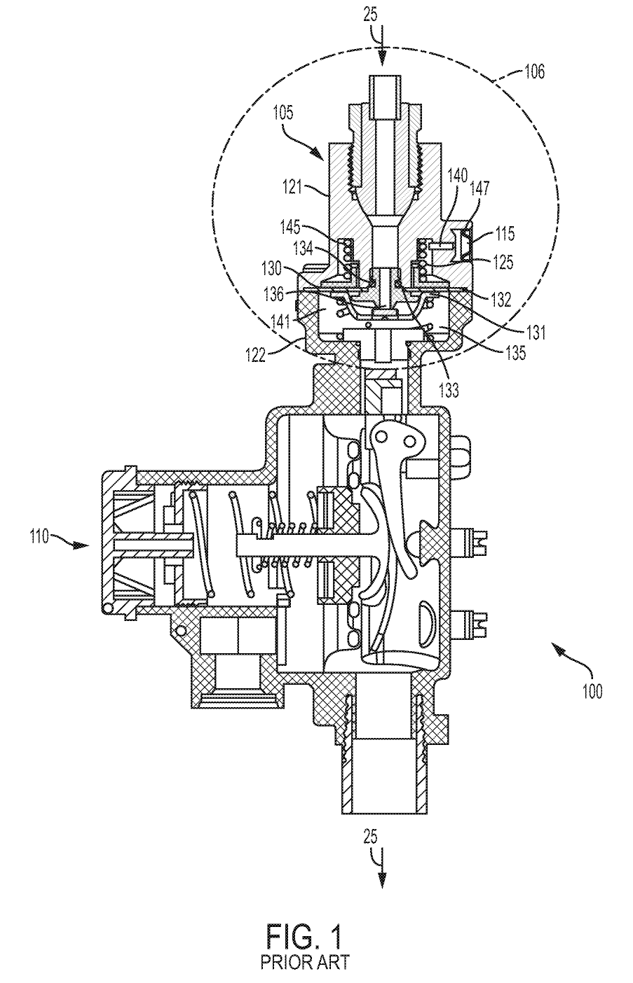

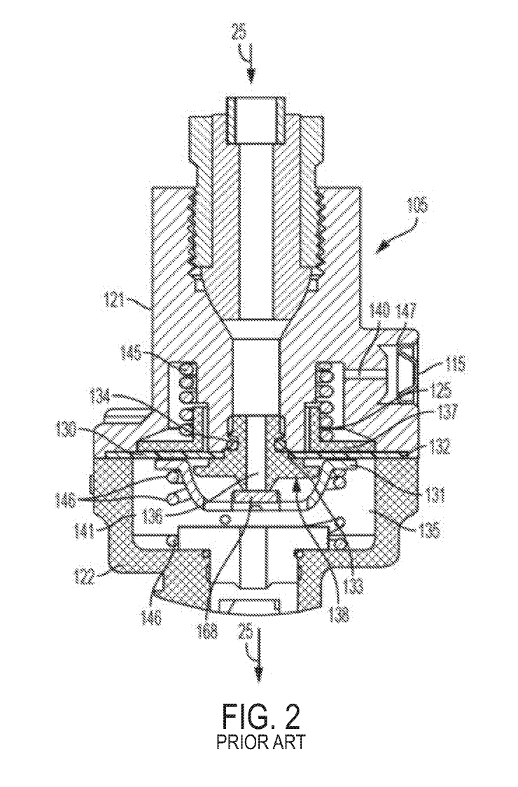

Referring to FIGS. 1 and 2, a prior art pressure regulator 100 is shown. The pressure regulator 100 is a dual-stage pressure regulator including a first stage 105 and a second stage 110. The first stage 105 reduces the pressure of a working fluid 25 coming out of, for example, a distribution system or unit, such as a propane storage tank (not shown), from about two hundred psi to about ten psi. Thus, about ten psi is the input pressure for the second stage 110. The second stage 110 further reduces the input pressure from the first stage 105. For example, the second stage 110 can reduce the approximately ten psi input pressure to about one-half psi output pressure. The regulator 100 shown in FIGS. 1 and 2 is conventional in the art and will not be described in detail herein. Additional description of a regulator similar to regulator 100 and particularly to the second stage 110 can be found in U.S. Pat. No. 9,709,998, the disclosure of which is incorporated herein by reference.

The first stage 105 includes a housing formed of an upper housing portion 121 and a lower housing portion 122 that are connected together with fasteners (not shown). The housing portions 121, 122 are formed of metal or other suitable material. Once connected, the housing portions 121, 122 define a compartment 141. The compartment 141 is separated by a pressure regulator diaphragm 130 into a non-working fluid chamber 125 and a working fluid chamber 135. The pressure regulator diaphragm 130 is held in place to seal the non-working fluid chamber 125 from the working fluid chamber 135. The pressure regulator diaphragm 130 is disc-shaped, having an outer periphery 132 that is held between the housing portions 121, 122. The diaphragm 130 has an inner periphery 133 that is held between a central fitting 134 and a nozzle 136, the nozzle 136 being screwed into the central fitting 134.

The pressure regulator diaphragm 130 is made of a flexible elastic material, and can also be, for example, integral, unitary, and one-piece. The pressure regulator 100 also includes a disc-shaped rigid diaphragm plate 137 placed in the non-working fluid chamber 125 and a cup shaped seal plate 131 placed in the working fluid chamber 135 on opposing sides of the pressure regulator diaphragm 130 to support the pressure regulator diaphragm 130.

The first stage 105 includes the nozzle 136. As the working fluid 25 flows through the first stage 105 of the pressure regulator 100, the working fluid 25 passes through the nozzle 136 and expands into the working fluid chamber 135, thereby reducing the pressure of the working fluid 25. The pressure regulator 100 also includes springs 145, 146 urging the plate 137 and valve cup 131, and positioned within the chambers 125, 135 and configured to control the movement of the diaphragm 130 in response to the pressure of the working fluid 25 to open and close the valve 138 to provide for a flow rate of working fluid 25 at the desired outlet pressure. A reduction in pressure in the working fluid chamber 135, which can be caused by downstream consumption or venting of the working fluid, results in flexing of the pressure regulator diaphragm 130 into the working fluid chamber 135. The amount of expansion of the pressure regulator diaphragm is controlled by the springs 145, 146 as known in the art. Such flexing of the pressure regulator diaphragm results in the valve 138 opening by moving the valve seat 168 away from the nozzle 136. High pressure working fluid 25 is driven by the pressure difference to pass through the pressure regulator 100 and through the valve 138 and into working fluid chamber 135. By controlling the flexing of the pressure regulator diaphragm 130, the springs 145, 146 control the opening of the valve 138 and thus the flow of the working fluid 25, thereby controlling the desired output pressure.

This flexing displacement of the pressure regulator diaphragm 130 results in an increase in the volume of the non-working fluid chamber 125 and a corresponding reduction in the volume of the working fluid chamber 135. The increase of the volume of the non-working fluid chamber 125 causes a reduction of the pressure in the non-working fluid chamber 125. In order to accommodate the changing volume and pressure caused by the movement of the pressure regulator diaphragm 130, the non-working fluid chamber 125 is in fluid communication with the atmosphere 220 (indicated in FIG. 6) through a vent 115. This permits, for example, the draw in, or as needed, the expulsion of the atmosphere fluids, such as air. The non-working fluid chamber 125 is connected to the vent 115 through a non-working fluid channel 140. The non-working fluid chamber 125, non-working fluid channel 140, and vent recess 147 defines a passage in fluid communication between the non-working fluid chamber 125 and the atmosphere 220. The vent 115 is located within the vent recess 147 and is sufficiently porous to permit draw in and expulsion of fluids, for example, moist air.

As discussed above, by exposing the non-working fluid chamber 125 via the vent 115 to the atmosphere 220, either liquid water or water vapor may enter the vent and the non-working fluid chamber 125. And as the pressure regulator 100 may be exposed to an environment below the freezing point temperature of water and/or by the cooling effect from expanding the working fluid 25, the water or water vapor could freeze within the non-working fluid chamber 125. To keep the moisture out of the pressure regulator, the non-working fluid chamber 125 may be sealed from the atmosphere 220. However, this may result in the non-working fluid chamber's volume, including connected passageways, being too small to accommodate volume changes caused by the movement of the pressure regulator diaphragm 130 without resulting in non-working fluid chamber 125 pressures undesirably resisting or interfering in the pressure regulator diaphragm's movement. This resistance may make it more difficult to precisely control flow of the working fluid 25 through the regulator 100.

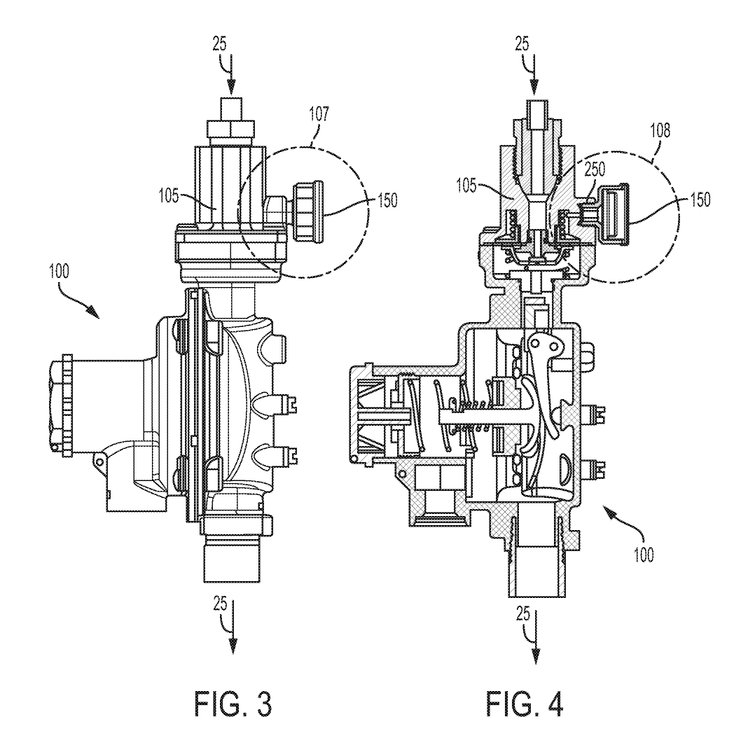

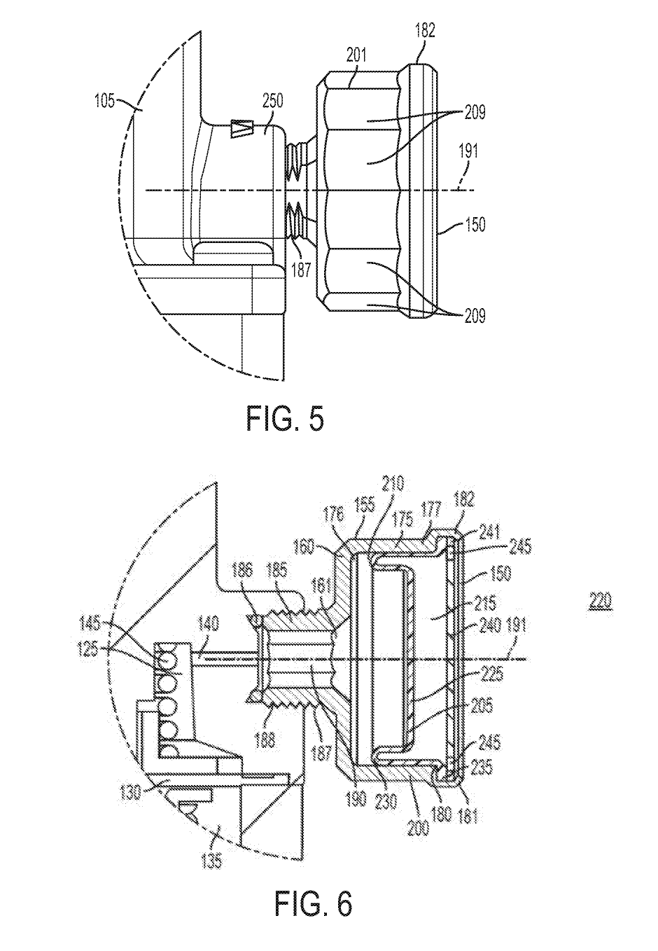

Referring now to FIGS. 3 through 6, there being shown the pressure regulator 100 with a vent device according to an embodiment of the disclosure. The vent device shown is further defined as a vent guard 150. The vent guard 150 is connected to the first stage 105 of the pressure regulator 100 at the vent location 250 (indicated in FIGS. 4 and 5). As indicated in FIG. 6, the vent guard 150 includes a vent guard housing 155 having a connection end 176 and a distal end 177. The vent guard housing 155 is generally cup-shaped and has a cylindrical vent guard housing side wall 200 and a disc-shaped base wall 160 at the connection end 176 of the vent guard housing side wall 200. The vent guard housing side wall 200 and the vent guard housing base wall 160 define a housing compartment 175. The vent guard housing 155 of the illustrated embodiment is metal. Alternatively, the vent guard housing 155 can be made from plastic or other suitable material. The distal end 177 of the vent guard housing side wall 200 ends in an annular inner lip 180 and an annular outer lip 181. The inner and outer lips 180, 181 form a C-shape protrusion 182 having the open portion of the C-shape directed towards the axial center 191 of the vent guard housing side wall 200.

The vent guard 150 has a threaded vent guard connector 185 for connecting to the regulator 100 at vent location 250. The vent guard connector 185 includes external threads 187. The vent guard connector 185 is integral to and projects outward from the vent guard housing base 160. The vent guard connector 185 further includes a central vent guard channel 190 extending through its length to connect and provide fluid communication between the vent guard pressure response chamber 210, described in additional detail below, and the non-working fluid chamber 125 via a hole 161 in the vent guard housing base wall 160. By means of the hole 161 in the vent guard housing base 160, the vent guard channel 190 is in fluid communication with the housing compartment 175. This configuration permits a fluid to pass from beyond the vent guard connector 185 through the vent guard channel 190 and the hole 161 in the vent guard housing base 160, and into the housing compartment 175. The vent guard connector 185 includes external threads 187 for attaching the vent guard connector 185 to the pressure regulator 100 at threaded vent location 250. As shown in FIG. 5, the exterior 201 of the vent guard housing side wall 200 is shaped to have opposed flat surfaces 209 to be engaged by a tool, for example, a wrench or ratchet, such that the tool can aid in fastening or attaching the vent guard 150 to the pressure regulator 100.

The vent guard 150 further includes a vent guard diaphragm 205, which is generally cup-shaped and positioned within the vent guard housing compartment 175. The vent guard diaphragm 205 is flexible and adapted to move towards and away from the vent guard base wall 160 in response to pressure changes within the housing compartment 175. The vent guard diaphragm 205 separates the vent housing compartment into two chambers sealed from one another, namely, a vent guard pressure response chamber 210 and a vent guard atmospheric chamber 215. As shown in FIG. 6, the vent guard pressure response chamber 210 is in fluid communication with the vent guard channel 190 via the hole 161. The vent guard atmospheric chamber 215 is in fluid communication with the atmosphere 220. When the vent guard 150 is installed in a pressure regulator, the vent guard pressure response chamber 210 and non-working fluid chamber 125 are in fluid communication and are sealed from the atmosphere by the vent guard diaphragm 205.

The vent guard diaphragm 205 is made of a flexible material capable of responsively moving within the housing compartment 175 in response to changes in pressure. The vent guard diaphragm 205 further includes a generally cylindrical vent guard diaphragm side wall 230 and a disc-shaped vent guard diaphragm base 225. The vent guard diaphragm side wall 230 extends from the vent guard diaphragm base 225 and ends in a vent guard diaphragm lip 235. The lip 235 extends in a continuous ring outwardly away from the axial center 191, forming a ledge. The vent guard diaphragm lip 235 is captured within the C-shaped protrusion 182 of the vent guard housing thereby sealing the vent guard pressure response chamber 210 from the vent guard atmospheric chamber 215. In order to respond to changes in pressure in the vent guard pressure response chamber 215, as discussed below, the vent guard diaphragm wall 230 flexes and folds back on itself, allowing the vent guard diaphragm base 225 to move in response to the changes in pressure in the vent guard pressure response chamber 210. Such movement of the vent guard diaphragm base 225 changes the volume of the vent guard pressure response chamber 210, to help normalize the pressure in the non-working fluid chamber 125 when the pressure regulator diaphragm 130 displaces the non-working fluid.

The vent guard 150 further includes a protective structure, such as the vent guard cover 240. The protective structure, which in this embodiment is vent guard cover 240, is positioned adjacent to the vent guard diaphragm lip 235. The periphery of the vent guard cover 240 is captured within the C-shaped protrusion 182. The vent guard cover 240 is positioned external to the vent guard diaphragm 205 such that the vent guard cover 240 is between the vent guard atmospheric chamber 215 and the atmosphere 220. The vent guard cover 240 together with the vent guard diaphragm 205 define the vent guard atmospheric chamber 215. The vent guard cover 240 can conform to the shape of the opening of vent guard housing side wall 200, thereby covering the entire opening. The vent guard cover may be made of metal, plastic, polymer, or a combination thereof, which is structurally sufficient to prevent debris from entering the vent guard atmospheric chamber 215. In order to permit fluid communication between the vent guard atmospheric chamber 215 and the atmosphere 220, the vent guard cover 240 is porous. The vent guard cover 240 includes periphery holes 245 located around the periphery 241 of the vent guard cover 240 and allows gases but not debris to pass through the vent cover. The location of the periphery holes 245 permits water drainage from the vent guard atmospheric chamber 215.

As described above, the vent guard pressure response chamber 210 is in fluid communication with the vent guard channel 190. The vent guard channel 190 and vent guard connector 185 are configured to join the vent guard pressure response chamber 210 with the non-working fluid chamber 125 of the pressure regulator 100. The vent guard 150 is attached to the pressure regulator through the vent location 250 (FIG. 4). If location 250 is an unthreaded existing vent recess 147 (FIG. 2), suitably threading can be formed as needed. The interior of the vent location 250 includes threads 188 corresponding to the threads 187 exterior to the vent guard connector 185. An O-ring seal 186 is included between the vent location 250 and the vent guard connector 185. Once connected to the pressure regulator, the vent guard 150 seals the non-working fluid chamber 125 from the atmosphere by placing the non-working fluid chamber in fluid communication with the vent guard pressure response chamber 210, which is sealed from the atmosphere 220 by the vent guard diaphragm 205. Thus, in an installed position, the vent guard diaphragm 205 seals the non-working fluid chamber 125, the non-working fluid channel 140, the vent guard channel 190, and the vent guard pressure response chamber 210 from the atmosphere 220. The vent guard atmospheric chamber 215 remains in fluid communication with the atmosphere 220, thereby permitting atmospheric gas to be drawn in or expelled from the vent guard atmospheric chamber 215 to allow the vent guard diaphragm 205 to flex in response to changing pressure in the non-working fluid chamber 125.

During operation of a first stage pressure regulator 105, the movement of the pressure regulator diaphragm 130 results in a displacement of fluid in the non-working fluid chamber 125, resulting in a change in pressure and volume of the non-working fluid chamber 125. For example, when the working fluid chamber 135 pressure decreases, the movement of the pressure regulator diaphragm 130 enlarges the volume of the non-working fluid chamber 125. In this situation, the difference in volume results in a decrease in pressure in the non-working fluid chamber 125 which needs to be normalized by either adding fluid to the non-working fluid chamber 125, for example, air in a system vented to the atmosphere, or changing the total volume of the non-working fluid chamber 125 and its connected passageways. As discussed above, in the installed position, the vent guard 150 is adapted to seal the non-working fluid chamber 125 from the atmosphere 220. Therefore, when the pressure regulator diaphragm 130 expands—reducing the pressure in the non-working fluid chamber 125, the vent guard diaphragm 205 moves in response to the reduction in pressure and reduces the volume of the vent guard pressure response chamber 210 to normalize the pressure within the non-working fluid chamber 125. Alternatively, when the pressure regulator diaphragm 130 moves to decrease the volume of the non-working fluid chamber 125, the pressure in the non-working fluid chamber 125 increases and the vent guard diaphragm 205 responds by moving to enlarge the volume of the vent guard pressure response chamber 210.

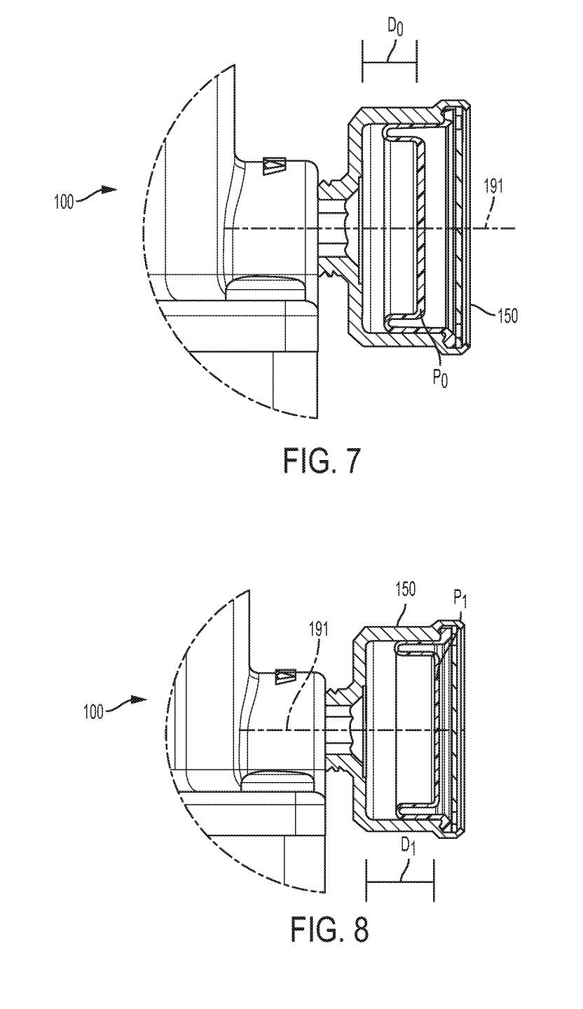

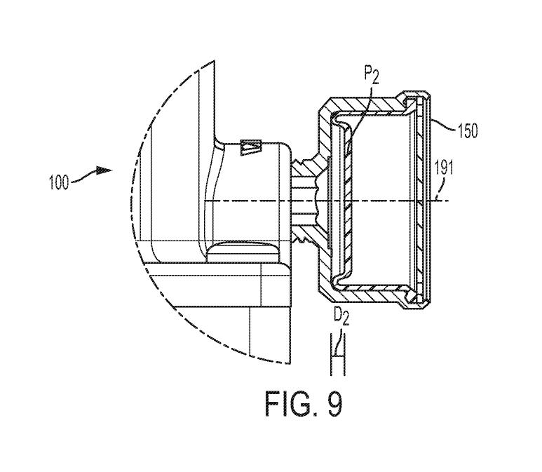

Referring to FIGS. 7 through 9, shown is the vent guard 150 with the vent guard diaphragm 205 at a range of positions. As previously described, the vent guard diaphragm 205 is movable within the housing compartment 175 and adapted to vary the responsive volumes of the vent guard pressure response chamber 210 and the vent guard atmospheric chamber 215. Shown in FIGS. 7 through 9 is the vent guard diaphragm at positions P0, P1, and P2, which correspond respectively to distances from the vent guard housing base 160, D0, D1, and D2. In an installed position, as the non-working fluid chamber 125 changes volume/pressure, the vent guard diaphragm 205 is adapted to respond by moving to different positions within the housing compartment 175 to normalize the pressure in the vent guard response chamber 210, thereby normalizing the pressure in the non-working fluid chamber 125. Thus, as shown in FIGS. 8 through 9, the vent guard diaphragm base is configured for a range of movement from P1 to P2, and, as described below, depending on the installation position, whether or not the working fluid is flowing through the pressure regulator, and the amount of displacement caused by the movement of the pressure regulator diaphragm.

The vent guard 150 can be installed in or attached to a pressure regulator while the pressure regulator working fluid chamber 135 is either pressurized or not pressurized. This can, for example, reduce installation cost and inconvenience by permitting the pressure regulator to remain in service when the vent guard is being installed.

As explained above, when the working fluid chamber 135 is not pressurized the pressure regulator diaphragm 130 moves thereby increasing the volume and decreasing the pressure in the non-working fluid chamber 125. When the pressure regulator working fluid chamber 135 is pressurized, the pressure regulator diaphragm 130 moves to decrease the volume and increase the pressure of the non-working fluid chamber 125. The vent guard diaphragm's initial at rest position, P0, permits installation, and subsequent operation, regardless of the position of the pressure regulator diaphragm 130 at the time of installation of the vent guard 150. As installed, the vent guard diaphragm base 225 is positioned at P0. If the working fluid chamber 135 was depressurized at the time of installation of the vent guard, when the working fluid chamber 135 pressurizes, the pressure regulator diaphragm 130 will move causing an increase in pressure in the non-working fluid chamber. In response to such movement of the pressure regulator diaphragm 130, the vent guard diaphragm 205 will respond to the pressure change and move to create more volume in the vent guard pressure response chamber 210, for example, by moving the vent guard diaphragm base 225 to position P1. In this scenario, when the working fluid chamber 135 returns to a depressurized state, the reduction of volume and associated increase pressure in the non-working fluid chamber 125 caused by the movement of the pressure regulator diaphragm 130 will result in the vent guard diaphragm returning to P0. If instead, the working fluid chamber 135 was pressurized at the time of installation of the vent guard 150, when the working fluid chamber 135 depressurizes, the pressure regulator diaphragm 130 will move to decrease the pressure in the non-working fluid chamber 125. In response to such movement of the pressure regulator diaphragm 130, the vent guard diaphragm base 225 will respond to the pressure change and move to create less volume in the vent guard pressure response chamber 210, for example, by moving to P2. If installed in this situation, once the working fluid chamber 135 re-pressurizes, the increase in volume and associated decrease in pressure of the non-working fluid chamber 125 caused by the movement of the pressure regulator diaphragm 130 will result in the vent guard diaphragm returning to P0.

As can be seen, the vent guard 150 can be installed whether the working fluid chamber 135 of the pressure regulator is pressurized or depressurized and is adapted to respond to changes in pressure in the non-working fluid chamber 125 during subsequent pressurizations or depressurizations of the working fluid chamber 135. The positions (P0, P1, P2) and distances (D0, D1, D2) specifically shown in FIGS. 7 through 9 are examples of different locations that the vent guard diaphragm base 225 may be positioned in during installation and operation; however, the vent guard diaphragm base 225 is positioned at the P0 location or other location within the housing compartment during installation, but preferably such that the vent guard diaphragm base has sufficient space and sufficient range of movement, such as between P0 and P2 to move to respond to changes in volume of the non-working fluid chamber in order to normalize the pressure in the non-working fluid chamber in response to movement of the pressure regulator diaphragm 130. As such, a particular advantage of the present disclosure is that the diaphragm 205 has a sufficient range of movement between P0 and P1, and between P0 and P2, such that the pressure regulator 100 does not need be to taken out of service for installation of the vent guard 150. The corresponding distances, D0, D1, and D2 exemplify the change in volume in the vent guard pressure response chamber 210. In response to changes in pressure in the non-working chamber 125, as shown in FIGS. 8 through 9, the vent guard diaphragm base 225 moves to a different position, for example, P1 or P2, resulting in a D1 or D2, thereby permitting additional volume or removing excessive volume of the vent guard pressure response chamber 210 to normalize the pressure in the non-working fluid chamber 125.

This disclosure also includes a method of regulating pressure. The method includes a step of regulating the pressure of a working fluid passing through a pressure regulator having a vent guard as described herein. As the pressure of the working fluid is reduced, the vent guard is configured to respond to the changing pressure of the non-working fluid chamber, while also preventing liquid water, water vapor, and/or debris from entering the non-working fluid chamber. The method includes a vent regulator diaphragm housed in the vent guard and adapted to move in response to changes in pressure of the non-working fluid chamber of the pressure regulator.

This disclosure also contemplates a method of installing the vent guard. The vent guard may be installed in a new pressure regulator prior to its installation in, for example, a service line, or the vent guard may be installed in a pressure regulator already in operation. The method can include removing a vent guard or cover from a pressure regulator. The method includes connecting the vent guard to the pressure regulator, thereby placing the vent guard in fluid communication with the non-working fluid chamber of the pressure regulator. The method may include connecting the vent guard to the pressure regulator using a threaded connector. By means of attached the vent guard, the non-working fluid chamber is sealed from fluid communication with the atmosphere and remains capable of responding to changes in pressure in the working fluid chamber.

An added benefit of using a vent guard as described in this disclosure is that such a configuration provides for an additional ease of installation of the pressure regulator by permitting the pressure regulator to be installed in any orientation, for example, either in a vertical or a horizontal orientation, and still comply with regulations as drainage of the non-working fluid chamber is not an issue with the vent guard.

By using a vent guard as described in this disclosure, the vent guard functions as intended, e.g., providing sealed relief to a non-working fluid chamber, regardless of the flow condition, i.e., the pressurization of the working fluid chamber, during installation of the vent guard. This provides the unique benefit of permitting installation of the vent guard without taking the pressure regulator out of service or limiting installation to certain flow conditions of the working fluid.

As an added benefit of this disclosure, by connecting and sealing the non-working fluid chamber with the vent guard pressure response chamber, a larger overall volume that is sealed from the atmosphere is provided to respond to changes in pressure of the working fluid chamber. This permits the present disclosure to provide for additional advantages during use of the pressure regulator, for example, which reducing the impact on performance of the pressure regulator in the event of an obstruction to the vent guard.

Moreover, because expansion of the working fluid can cause the internals of the pressure regulator to reach a temperature below the freezing point of water, an added benefit of the present disclosure is to seal the non-working fluid chamber from the atmosphere, thereby preventing water or water vapor for accumulating within the pressure regulator. To the extent that the present invention utilizes a movable diaphragm to respond to changes in pressure, the movable diaphragm is also located outside the pressure regulator, thereby insulating the movable diaphragm from the temperatures internal to the pressure regulator.

The above description and drawings are only to be considered illustrative of specific embodiments, which achieve the features and advantages described herein. Modifications and substitutions for specific conditions and materials and otherwise can be made. For example, it should be appreciated that the specific pressure set points described with respect to the pressure regulator 100 are not intended to limit the present disclosure. In other embodiments, the vent guard 150 could be used in conjunction with second stage 110 (FIG. 4) of a pressure regulator, any stage in a pressure regulator having two or more stages, or in a one stage pressure regulator. In some embodiments, vent guard 150 is integral to pressure regulator 100. Accordingly, the inventions are not considered as being limited by the foregoing description and drawings, but are intended to embrace all such alternatives, modifications, substitutes and variances.

1. A pressure regulator vent guard configured to be in fluid communication with a non-working fluid chamber of a pressure regulator diaphragm, the pressure regulator vent guard comprising:
a housing defining a compartment;
a vent diaphragm configured to separate the housing compartment into a pressure response first vent chamber and an atmospheric second vent chamber, the first vent chamber adapted to be in fluid communication with the non-working fluid chamber, and the second vent chamber in fluid communication with an atmosphere;
wherein the vent diaphragm is adapted to seal the non-working fluid chamber from fluid communication with the atmosphere; and
wherein the vent diaphragm is adapted to move to increase or decrease a volume of the first vent chamber in response to changes in pressure in the non-working fluid chamber.

2. The pressure regulator vent guard of claim 1, wherein the housing comprises a vent connector adapted to connect with a pressure regulator diaphragm inlet channel and to establish fluid communication between the pressure regulator vent guard and the non-working fluid chamber.

3. The pressure regulator vent guard of claim 2, wherein the housing comprises a cylindrical housing side wall connected at one end to a circular disc shaped housing base to define the compartment, and a connector extending outwardly from the housing base, wherein the connector is adapted for connection with the pressure regulator.

4. The pressure regulator vent guard of claim 3, wherein the connector includes a channel adapted to provide fluid communication between the non-working fluid chamber and the first vent chamber.

5. The pressure regulator vent guard of claim 3, wherein the housing side wall ends in an inner housing lip and an outer housing lip, the inner and outer housing lips forming a C-shaped protrusion.

6. The pressure regulator vent guard of claim 1, wherein the vent diaphragm includes a generally conical flexible diaphragm side wall, a disc shaped base at one end of the diaphragm side wall, and a vent guard diaphragm lip extending outwardly from the circumference of the vent guard diaphragm lip.

7. The pressure regulator vent guard of claim 6, wherein the diaphragm side wall is adapted to include a U-shape portion so that the base and part of the diaphragm side wall proximate the base is positioned within a portion of the side wall proximate the vent diaphragm lip.

8. The pressure regulator vent guard of claim 6, wherein the vent diaphragm lip is in held in a concave side of the C-shaped protrusion of the annular housing wall.

9. The pressure regulator vent guard of claim 6, wherein the pressure regulator vent compartment and vent diaphragm are sized so the vent diaphragm has sufficient range of travel within the compartment to move to respond to increases and decreases of pressure in the first vent chamber by adjusting a position of the vent diaphragm base to change a volume of the first vent chamber, and the pressure regulator vent guard has a sufficient volume that from an installation position the pressure regulator vent guard can flex to respond to an increase or a decrease in pressure in the first chamber to substantially equalize the pressures, regardless of whether the vent guard is installed with the pressure regulator pressurized or unpressurized.

10. The pressure regulator vent guard of claim 1, further comprising a protective structure adapted to prevent ingress of debris from the atmosphere to the second vent chamber, wherein the protective structure is porous to permit the ingress of gas from the atmosphere to the second vent chamber and the drainage of moisture to the atmosphere from the second vent chamber.

11. A pressure regulator comprising:
a pressure regulating stage, the pressure regulating stage comprising:
a movable regulator diaphragm separating a non-working fluid chamber from a working-fluid chamber; and
a pressure regulator diaphragm vent channel in fluid communication with the non-working fluid chamber; and
a vent guard in fluid communication with the non-working fluid chamber through the vent channel, the vent guard comprising:
a housing comprising a compartment;
a vent diaphragm configured to separate the housing compartment into a first vent chamber and a second vent chamber, the first vent chamber in fluid communication with the non-working fluid chamber, and the second vent chamber in fluid communication with an atmosphere,
wherein the vent diaphragm seals the non-working fluid chamber from fluid communication with the atmosphere.

12. The pressure regulator of claim 11, wherein the vent guard further comprises:
a vent guard connector adapted to connect the vent guard to the pressure regulating stage and promote the fluid communication between the non-working fluid chamber and the first vent chamber.

13. The pressure regulator of claim 11, wherein the vent diaphragm is adapted to move to increase or decrease a volume of the first vent chamber in response to the fluid communication with the non-working fluid chamber.

14. The pressure regulator of claim 12, wherein the vent guard connector is threaded to engage threads on the pressure regulator to secure the vent guard to the pressure regulator.

15. The pressure regulator of claim 14, wherein the exterior of the vent guard housing includes opposed surfaces for engagement by a driving tool for insertion and removal.

16. The pressure regulator of claim 11, wherein the vent guard further comprises a protective structure adapted to prevent ingress of debris from the atmosphere to the second vent chamber.

17. The pressure regulator of claim 12, wherein the vent guard connector is sized to provide thermal isolation of the vent guard compartment from the pressure regulator.

18. A method of regulating pressure comprising:
reducing a pressure of a fluid passing through a pressure regulator, wherein the pressure regulator comprises a non-working fluid chamber in fluid communication with a vent guard,
wherein the vent guard comprises:
a housing defining a compartment; and
a vent diaphragm adapted to separate the housing compartment into a first vent chamber and a second vent chamber, the first vent chamber adapted to be in fluid communication with the non-working fluid chamber, and the second vent chamber in fluid communication with an atmosphere, wherein the vent diaphragm seals the non-working fluid chamber from fluid communication with the atmosphere.

19. A method of installing a vent guard comprising:
providing a pressure regulator comprising a non-working fluid chamber in fluid communication with a non-working fluid channel; and
connecting a vent guard to the pressure regulator thereby sealing the non-working fluid chamber from fluid communication with an atmosphere, wherein the vent guard is adapted to be connected either when the pressure regulator is pressurized or when the pressure regulator is not pressurized,
wherein the vent guard comprises:
a housing comprising a compartment; and
a vent diaphragm configured to separate the compartment into a first vent chamber and a second vent chamber, the first vent chamber adapted to be in fluid communication with the non-working fluid chamber of the pressure regulator, and the second vent chamber in fluid communication with the atmosphere, wherein the vent diaphragm seals the non-working chamber from fluid communication with the atmosphere.

20. The method of installing the vent guard of claim 19, wherein connecting the vent guard includes using a tool to engage engagement surfaces on the outside of the vent guard housing.
